(19) United States
(12) Patent Application Publication
(10) Pub. No.: US 2010/0024845 A1
(43) Pub. Date: Feb. 4, 2010

(54) PROCESS AND APPARATUS FOR DEGREASING OBJECTS OR MATERIALS BY MEANS OF OXIDATIVE FREE RADICALS

(76) Inventors: Primoz Eiselt, Graz (AT); Uros Cvelbar, Idrija (SI); Miran Mozetic, Ljubljana (SI)

Correspondence Address: Workman Nydegger;1000 Eagle Gate Tower, 60 East South Temple, Salt Lake City, UT, 84111, US

(21) Appl. No.: 12/447,097

(22) PCT Filed: Oct. 3, 2007
(86) PCT No.: PCT/AT2007/000467

§ 371 Date: Jun. 18, 2009

(30) Foreign Application Priority Data
Oct. 25, 2006 (AT) A 1800/2006

(51) Int. Cl. B08B 7/00

(52) U.S. Cl. 134/21; 134/122 R

(57) ABSTRACT

A method and device for degreasing of long products or endless materials such as metal, plastic or ceramic wires, bands, tapes, and tubes or any other materials surfaced with oil or other hydrocarbons. Long products are exposed to chemically reactive oxidative radical environment, wherein the degreasing is done at low pressure. Material coming from device, treated by this method, becomes clean, functionalized and more susceptible for any material deposition on its surface. The method for non contact cleaning of material is environmentally friendly and presents an alternative to classical wet degreasing or heat degreasing.

The present invention relates generally to the fabrication of long product or endless material. More particularly, the invention relates to a method for non contact degreasing with highly chemically reactive oxidative radicals of materials covered with oil and other hydrocarbons or organic impurities.

The long products or endless materials such as metal, plastic or ceramic wires, bands, tapes, and tubes or any other materials, become or are already surface contaminated with organic material and impurities during their production. Contamination is due to the contact of manufacturing material with production machines. More often, the components are also polluted with different organic and inorganic impurities. Organic impurities are often residues of oil or grease and other hydrocarbons applied during machining. Inorganic impurities include oxides as well as chlorides and sulphides. The thickness of inorganic impurities on surfaces depends on the environment in which the long products were stored as well as the environment temperature. But the thickness of organic impurities often depends only on material contact properties with machining material.

The layer of oil and other organic impurities on endless material should be removed prior to printing, painting, gluing, soldering, welding or metallization in order to assure good quality of processing. Traditional methods of degreasing include mechanical, chemical and heat treatments. Mechanical degreasing is often performed by brushing or sand blasting, while chemical cleaning is performed by dipping components in agent solution of chemicals, typically followed by rinsing with distilled water. Removal is also possible by heating the surface to high temperature to decompose oil or evaporate it from the surface.

In some cases, however, traditional degreasing or cleaning methods do not assure needed cleanliness of the endless material. A thin layer of oil and other organic impurities often still persists on the surface, when the classical degreasing is performed. To ensure better material cleanliness, non destructive and non contact degreasing is needed that does not modify the original material surface. Therefore, there is a need for an improved degreasing process that removes surface organic material and impurities, and is a good alternative to classical processes.

According to prior art degreasing is traditionally performed with wet chemical procedures, where the material covered with oil, hydrocarbons or other organic impurities is exposed to degreasing agent, normally prepared in liquid solution. In many cases, water is used as the agent carrier. Such wet chemical degreasing is used as a pretreatment to different production procedures (JP11200888, JP57039182, HU45091, JP60226873, JP61247740).

An alternative to classical wet chemical degreasing is thermal procedure by heating material to specific high temperatures from 600 to 900° C. in a heating furnace (JP63215316) or just thermal heating from 700 to 900° C. (JP3283321). Problems with both degreasing methods exist. In wet chemical degreasing, solvents and detergents mixed with oil or other hydrocarbons represent a problem as a waste that is difficult to purify and disintegrate, and is therefore ecologically unfriendly. The problem exists also with high temperature degreasing where chemical substances are volatilized with high temperature or/and removed by filtering (WO0061283). These volatilized substances are normally condensed on lower temperature parts of the system, and therefore cannot be completely removed from the system or they can even escape filtering in small percent, and therefore are released to environment.

The third alternative is degreasing with ignited or discharge gas atmosphere. There are different possible procedures to do the degreasing, but the main difference is the radicals used for it. The most interesting is oxidative atmosphere. In most cases oxygen ions are used. Reactive oxidative atmosphere is used only with small radical densities. The radicals can be created in a gas discharge or a liquid bubble discharge. Typically in water, a high voltage pulse creates the so called bubble discharge, where oxidative radicals, mainly ions, are produced inside the bubble (JP2005058887). Organic material in water interacts with the bubble atmosphere and gets decomposed.

Beside radical treatment in liquid medium, the most common treatment is treatment with gas discharge, many times in specific conditions called plasma. There are numerous different types of plasmas, generally divided to thermal and thermodynamic non-equilibrium plasmas. Interesting are non-equilibrium plasmas created in electrical discharge that also defines the type of radical created in discharge. There are no reports on plasma or oxidative radical degreasing of endless material or long products. For long products like wires, a report on discharge treatment of gold or gold alloy wire, found in pat. JP2000106384, was applied during the production to increase bonding. The wire is subjected after annealing at 500° C. to either of argon-hydrogen plasma treatment or alkaline electrolytic degreasing treatment in low vacuum.

Treatment of the surface with plasma gas containing oxygen is not a new procedure. In most cases, the plasmas are mostly ionized and have low density of chemically reactive oxidative radicals inside electrical discharge. Highly ionized plasma was applied for degreasing samples during CVD or PVD deposition of thin films, where magnetron sputtering was used. The degreasing is in the case of sputtering the result of physical interaction of oxygen ions with the surface (JP2004315250) of material from which surface hydrocarbons and also surface material leaving defects on treated material are removed. Sputtering can be improved by adding heavy inert atoms like argon. More selective is oxygen reactive ion etching where the surface hydrocarbon film can be removed by oxygen ions or a mixture of oxygen ions with other inert gas ions as a part of the degreasing method (DE19644153). Typically, very ionized plasma with low density of chemically reactive radicals can be created in an electrical discharge between two or more metal electrodes, sliding between them at a high voltage (FR2774400, JP6280071), many times also called arc discharges. Such a discharge can also be applied for metal surface treatment like degreasing, pickling or passivation. To create such a discharge, pressure in the reactor chamber has to be lower than 1 bar. In some cases, such plasma is created between 10⁻² -10 Torr, like for degreasing a press-molding body by heating the thermosetting binder-containing press-molding body under plasma ionised atmosphere including oxygen (JP325302).

Degreasing connected with surface deoxidation can be also done by some other radicals created in an electrical discharge of hydrogen gas. In the pat. WO9946428 such procedure is disclosed, where radicals are created in microwave ECR (electronic cyclotronic resonance). Generally, radicals created in this discharge are mostly ions with a lower friction of chemically reactive radicals like neutral atoms.

As already stated, there are no patents on degreasing of long products or endless material with a high dose of oxidative radicals at low pressure, preferentially chemically reactive oxidative radicals, where oil or other hydrocarbons are removed, leaving the surface without structure damages.

The present invention provides a process for degreasing surfaces of running long products or endless materials, primarily from metal materials like iron or its alloys. The long products or endless materials are dragged through at least three chambers, where all three have the pressure lower than air atmospheric pressure. The low pressure is achieved by one or more vacuum pumps that pump one or all three chambers at the same time. The preferential pressure in all reaction chambers is less than 100 mbar. The first and third chambers, also called the pre-chambers, are preventing leakage of unwanted gas or air into the second chamber, also called the reaction chamber. In the reaction chamber, gas molecules get dissociated into chemically reactive radicals, preferentially neutral atoms which then interact with the surface of long products or endless materials. To enhance the density of particular radicals, a gas or a mixture of gases is leaked into the reaction chamber or even into the pre-chambers, and an appropriate high frequency electrical discharge is ignited. The high frequency discharge assures a high dissociation of molecules and a low ionization fraction. The endless material receives a high dose of chemically reactive radicals which interact with the surface impurities. The right dose of radicals is achieved through variation of partial pressure in the chambers, pumping speed, pressure of gas leaked into chambers, gas mixtures, discharge power, discharge type and type of the reaction chamber walls. High radical dose influx onto material surface results in oil, organic material or impurities removal from treated surface. The best results of organic material removal are achieved in oxidative environments with a high dose of oxidative radicals, created inside plasma, preferentially generated in inductively coupled high frequency discharge. Oxidative radicals that are produced in the discharge interact with organic surface materials or impurities oxidizing them to water vapour and carbon oxide that are desorbed from the surface and pumped away. After oxidizing plasma treatment, the surface becomes free of organic material. Due to oxygen polar groups formed on the surface, the material is functionalized and activated. Such surface is then ready for further processing and deposition or bonding with other materials including glue, paint and solder.

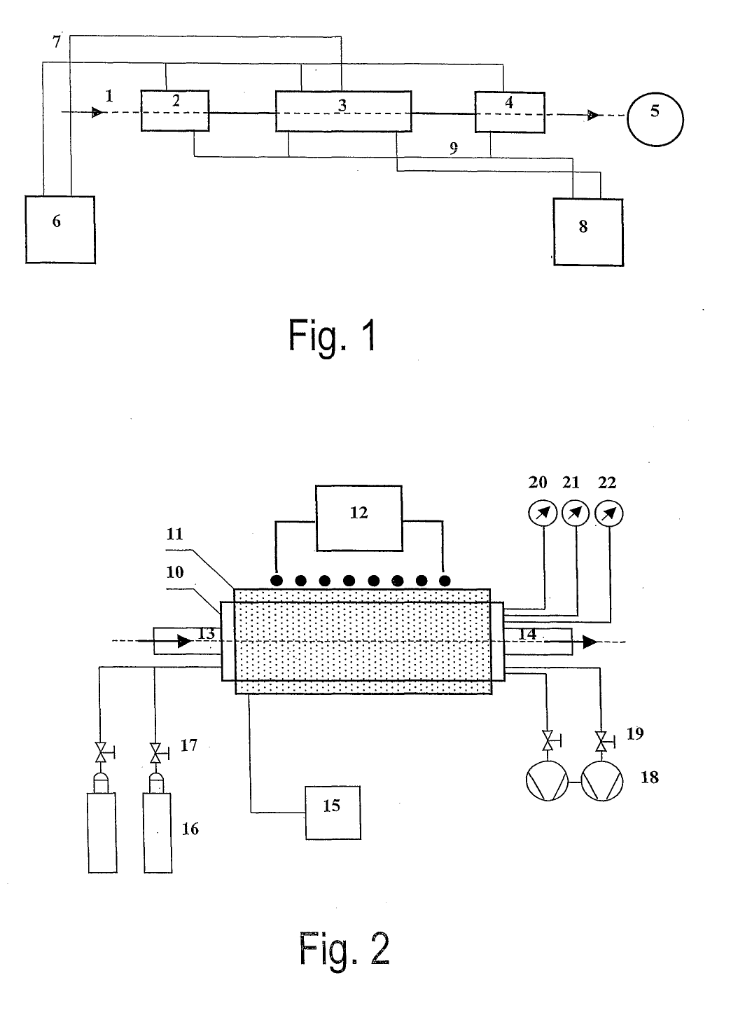

FIG. 1 is a schematic of the system, representing an example of a system used for plasma degreasing material of long product or endless material.

FIG. 2 is a schematic of the reaction chamber for achievement of high reactive radical dose.

There are a number of distinct advantages in the use of hereinafter described method for treatment of long product or endless materials that enables degreasing and removal of organic material, oil or other hydrocarbons and impurities. By using oxidative reactive radical environment, the organic material is not only removed, but the surface exhibits better adhesion for most materials since it is functionalized with polar groups. The material temperature is low after the treatment and much lower than the melting point of treated material. This method for removal is also ecologically benign, and does not use any toxic material.

In schematic FIG. 1 a system setup for degreasing of long products or endless material is presented, where organic material or impurities are removed from surface. The system comprises the long material 1 that is led into a first pre-chamber 2, the reaction chamber 3, a second pre-chamber 4. The long material 1 is drawn by a traction machine 5. Gases 6 are fed to the chambers 2, 3, 4 by a gas feeding system 7. The low pressure in the chambers 2, 3, 4 is established by a vacuum pipe system 8 with valves that is connected to a vacuum pumping system 9. The long product is dragged through all three chambers with traction machine 5 at a desired traction speed. At first, the long product 1 in the form of a wire, band, tape or tube made from metal, plastics or ceramics enters into a pre-chamber 2. The first chamber called the pre-chamber 2 is pumped with one or more pumps to reduce the partial pressure in the system and prevents the entrance of undesirable gases into reaction chamber 3. The pressure in chamber 2 is reduced from outside air atmospheric pressure to a pressure lower than 100 mbar. To prevent leakage of undesirable gases or outside air, a gas like argon can be also leaked into the chamber 2. The long product is dragged further into the reaction chamber 3. In the reaction chamber, the dissociation of molecular gas or gas mixture is created, resulting in different reactive radicals, preferentially the oxidative radicals like neutral oxygen atoms or OH molecules. The oxidative gas is leaked into the chamber 3 from the gas storage 6 through the gas feeding system 7. In the reaction chamber, the dissociation of molecules is created by electrical discharge, gas discharge, plasma or thermal discharge. The best dissociation is preferentially created with a high frequency discharge, like radiofrequency or microwave discharge. Creation of discharge results in plasma rich in chemically reactive radicals that interact with long product material, removing organic material or impurities. Typically, the radicals remove hydrocarbons, like oil, grease, etc., and chemical pollutants like sulphides or chlorides. The result of interaction is creation of water, hydroxides and carbon oxides that are desorbed from the surface and pumped away through the vacuum pipe system with valves 9 into vacuum pumps 8 and exhausted into the environment. Degreased long product is then dragged into second pre-chamber 4 that has the same function as the first pre-chamber 2. It prevents leakage of unwanted air and creates residual atmosphere with vacuum system. The long product after pre-chamber 4 continues into next process phase.

The most important parts of the system are presented more in detail in FIG. 2, where the schematic of the reaction chamber with applied systems is shown. The reaction chamber part comprises a chamber 10 also called first wall chamber, temperature regulation chamber 1, system for temperature regulation 15 and generator of discharge 12. To the chamber 10, the endless material inlet 13 and outlet 14 parts are attached from side. Gas is fed into chamber 10 from gas flasks 16, through gas valves 17. Low pressure inside chamber 10 is created with vacuum pumps 18 separated from the chamber with pump valves 19. The pressure inside chamber 10 is controlled by vacuum gauge 20, the radical densities by catalytic probes 21 and the radical species by optical spectrometers 22. During the production, the endless material is led through inlet part 13 into chamber 10. The inlet part is connecting the reaction chamber with the pre-chamber. The inner wall of chamber 10 is made from material with a low recombination coefficient for reactive radicals to prevent wall losses of radicals on the chamber surface. The inner chamber wall 10 and reactions on the wall are also influenced by wall temperature; therefore temperature regulation chamber 11 is made to control reactor temperature through temperature regulation system 15. To ensure high dissociation of gas molecules the appropriate generator of discharge 12 is used. Very high dissociation of gas molecules is achieved using high frequency generator; radiofrequency or microwave generator.

To get enough chemically reactive radicals, particularly oxidative radicals, appropriate gas or gas mixture has to be leaked into the reaction chamber from different flasks 16 thru gas valves 17. The simplest gas to create oxidative radicals is oxygen. Dissociation of oxygen can be in many times improved by adding a noble gas like argon, helium, xenon or neon. The source of oxygen radicals leaked into reaction chamber can be also prepared from gas or liquid such as water, water vapour, hydrogen peroxide, hydroxyl, ethanol and carbon dioxide. The dissociation of these chemical substances can be also improved by adding noble gases, especially argon, because additional noble gas increases the collision probability inside plasma and therefore probability of molecule dissociation. The air is also gas that gives enough oxidative radicals for treatment, but better dissociation can be achieved in the gas mixture or air and noble gas. The time of long product or endless material treatment to reduce organic material mostly depends on oxidative radical density inside reactor. To achieve efficient degreasing and removal of the organic material from the surface, oxygen radical density must exceed density 1E21 mE-3. If the surface of material is big, then the dose of radicals generated in reaction chamber and supplied to the material surface must exceed 1E24 mE-2. The density and dose of radicals is also controlled by gas pressure in reaction chamber with vacuum gauge 20 and catalytic probes 21. To ensure efficient control of the process the optical spectrometer 22 is also used. The highest dose of reactive radicals is achieved in gas or mixture pressures around 1 mbar, but depends also on parameters like discharge power of generator, discharge configuration, gas or mixture type, material temperature and type, pumping speed, etc. The oxidative radicals created inside discharge interact with material surface and remove organic material and impurities, in our example with iron band covered with oil. Most interactions happen through chemical interaction of neutral oxygen atoms with oil hydrocarbons. The chemical reactions of oxygen atoms produce mostly OH and CO molecules that are desorbed from material surface and pumped away. The desorbed reaction product molecules are on the way to pumps mostly recombined into water and carbon dioxide gas. The long product surface stays virtually organic material free after the treatment, with only thin atomic oxide layer on the surface and polar groups containing oxygen.

1. A method for degreasing of long products or endless material, comprising:
leading the material through a reaction chamber, where the pressure is below the atmospheric pressure;
pumping the said reaction chamber on one or more areas with vacuum pumps;
leaking reactive gas continuously into the said reaction chamber at one or more sites;
wherein the said reactive gas molecules are dissociated inside the chamber into oxidative radicals;
treating the material by a high dose of said oxidative radicals.

2. The method according to claim 1, wherein the said oxidative radicals are oxygen atoms or/and OH molecules.

3. The method according to claim 1, wherein the said reactive gas is oxygen or a mixture of a noble gas and oxygen.

4. The method according to claim 1, wherein the said reactive gas is water vapour, or/and hydrogen peroxide, or/and ethanol, or any mixture of these gases with a noble gas or/and oxygen.

5. The method according to claim 1, wherein the said reactive gas comprises:
carbon dioxide;
a mixture of carbon dioxide with a noble gas;
oxygen;
a mixture of oxygen with a noble gas; or
water vapour or/and hydrogen peroxide, or/and ethanol, or any mixture thereof with a noble gas or/and oxygen.

6. The method according to claim 1, wherein the said oxidative radicals are created by an electrical discharge that is inside in the said reaction chamber.

7. The method according to claim 1, wherein the density of the said oxidative radicals in the said reaction chamber exceeds the value of 1E21 mE-3.

8. The method according to claim 1, wherein the dose of said oxidative radicals onto the said long product surface is more than about 1E24 mE-2.

9. A device for carrying out a method for degreasing of long products or endless material, comprising:
holders and a traction system of long or endless material;
a first pre-chamber evacuated down to a pressure lower than atmospheric pressure, preferentially lower than 100 mbar, wherein the said pre-chamber is placed in front of the said reaction chamber;
a reaction chamber within which a reactive gas is leaked and within which oxidative radicals are created;
a back pre-chamber with a pressure lower than air atmospheric pressure that is placed behind the said reaction chamber;
vacuum pumps;
a discharge generator.

10. The device according to claim 9, wherein the said discharge generator is a high frequency generator.

11. The device according to claim 10, wherein the said high frequency generator is inductively coupled to plasma.
